(19) United States
(12) Patent Application Publication
(10) Pub. No.: US 2008/0288423 A1
(43) Pub. Date: Nov. 20, 2008

(54) SYSTEM AND METHOD FOR PROVIDING ACCESS TO A NETWORK

(76) Inventor: Jon Eastman, Beverly Hills, CA (US)

Correspondence Address: KLEIN, O'NEILL & SINGH, LLP, 43 CORPORATE PARK, SUITE 204, IRVINE, CA, 92606, US

(21) Appl. No.: 11/749,107

(22) Filed: May 15, 2007

(51) Int. Cl. G06F 17/00

(52) U.S. Cl. 705/418; 705/400

(57) ABSTRACT

A method provides access to, and time for, using a network associated with a commercial establishment through a proxy server. The method enables access to the proxy server within a selected physical area adjacent to the commercial establishment; establishing data communication between a cash register within the commercial establishment and the proxy server; and enabling network access for a given time duration related to a commercial transaction between the customer and the commercial establishment. The transaction my include trade dealing in cash, airline miles or other point based system, certificates, coupons and any other trade related instrument.

### BACKGROUND OF THE INVENTION

This disclosure relates generally to methods and systems for gaining access to networks such as the Internet and other wide area networks (WANs), and more particularly to methods and systems for gaining access to networks within a local area made available by a commercial establishment within a local area.

Network users access so called wide area networks, such as the Internet, using different methods. The term “network” is used herein to refer to any local or wide area network; the Internet, intranets, and so on. Most users access a network by obtaining an account with an Internet service provider (ISP). In this case users are generally provided with a user name and password. Each time such a user accesses the network, his user name and password is provided to the ISP to validate the user. Typically, the user name and password is communicated in the background and the user never sees the transmission. Users also gain access to a network at their place of employment by logging on to a company intranet. In both of these cases network access is controlled.

There are times where a user would like access to a network when not at home and not at work. In this case users generally must access the network in a public venue such as a hotel room, airport, coffee shop, designated public area, trade show, or any other venue that may offer network access. In these situations the user typically does not have an account with which to access the network. In some instances a venue offers network access without charge by simply making the network signals available to anyone without requiring a username and password. However, more often than not a service provider controls network access at a public venue. For instance, T-mobile and Boingo are examples of companies that control many “Hot Spots,” or areas that have Wi-Fi® access. In such instances, if a user is a member of the T-mobile network, for example, then the user can access the network with a T-mobile user name and password. If a user is not a member, then the user can subscribe or purchase a one time usage. In these cases the relationship is between the user and the access point provider or service provider.

Unfortunately, the venue owner may be unable to exercise control, if desired, over network access in such instances.

### BRIEF SUMMARY OF THE INVENTION

In one aspect the invention provides a method which gives venue operators/owners the ability to control access to a network such as the Internet.

In one aspect the invention provides a method that enables the venue operator to provide complimentary Internet access based on the amount, for example in dollars, of goods or services purchased at the venue.

In one aspect the invention provides a method that enables the venue operator to provide complimentary Internet access based on the amount, for example in dollars, of goods or services purchased at the venue.

In one aspect the invention provides a method including a gift card having a magnetic strip encoded with a purchase credit useable for purchases of goods or services at the venue, and also having an access code (“AC”), which may be printed, for controlled use of the Internet.

In one aspect the invention provides a receipt including an AC, the AC providing usage of the Internet for a time period corresponding to the amount of an associated purchase.

In one aspect the invention provides a time or byte allotment for network access as well as a time period or window for using the allotment.

In one aspect the invention provides an AC on a memory device such as a USB compatible memory key, smart card, or other data storage device.

In one aspect the invention provides an AC with an allotment of network access time determined based on points earned, frequent flyer miles, dollars spent, number of times visiting a store, or any other valuable commodity.

In one aspect the invention provides an AC for a Wi-Fi® phone or dual Cellular/Wi-Fi® phone for access to the network and where the AC is input using the phone's keypad.

In one aspect the invention provides an airline ticketing computer for use in issuing an AC for access to a network from an airline waiting area.

In one aspect the invention provides users with the ability to purchase a time or byte allotment of network access time or use from a kiosk.

Other features and advantages of the present invention will become apparent from the following more detailed description, taken in conjunction with the accompanying drawings, which illustrate, by way of example, the principles of the presently described apparatus and method of its use.

### BRIEF DESCRIPTION OF OF THE DRAWINGS

Illustrated in the accompanying drawings are embodiments of the present invention In such drawings:

FIG. 1 is a block diagram showing one aspect of the invention, a single venue configuration wherein an access point may be located at the venue or elsewhere;

FIG. 2 is a logic flow diagram of a method showing one aspect of the invention, for providing an access code;

FIG. 3 is a logic flow diagram of a method showing one aspect of the invention, for providing an access code and recording it;

FIG. 4 is a logic flow diagram of a method showing one aspect of the invention, for gaining access to a network by entering the access code;

FIG. 5 is a logic flow diagram of a method showing one aspect of the invention, for granting access codes and gaining access to a network;

FIG. 6 is a block diagram showing one aspect of the invention, a single venue configuration;

FIG. 7 is a logic flow diagram of a method showing one aspect of the invention, for providing an access code with any optional promotions and recording the access code with other information;

FIG. 8 is a logic flow diagram of a method showing one aspect of the invention, for gaining access to a network and checking other pertinent parameters;

FIG. 9 is a sample printed receipt from a cash register, the receipt having a time and date stamp at the top indicating the time and date the transaction occurred and at the bottom of the receipt, an AC, number of minutes allowed, and an expiration time, date and optionally a Venue ID;

FIG. 10 is a block diagram showing one aspect of the invention, a multiple venue configuration;

FIG. 11 is a block diagram showing one aspect of the invention, a single venue configuration wherein an interactive voice response unit (IVR) is used;

FIG. 12 is a logic flow diagram showing one aspect of the invention, and representing a method for controlling network access utilizing an IVR;

FIG. 13 is a database table where the primary key is an access code and wherein the relationship between the access code, venue ID, promotional code, transaction amount, transaction date, transaction time, allotment allocated, and allotment remaining is shown;

FIG. 14 is a database table related to the table in FIG. 13, where a primary key is a venue ID, and wherein the relationship between the venue ID, promotional code, transaction threshold, allotment, and window is shown;

FIG. 15 is a database table showing one aspect of the invention, wherein the primary key is the MAC Address of the venue proxy server, gateway, or router, and maps to the Venue ID.

The above described drawing figures illustrate the described apparatus and its method of use in several preferred embodiments, which are further discussed in detail in the following description. Those having ordinary skill in the art may be able to make alterations and modifications to what is described herein without departing from its spirit and scope. Therefore, it must be understood that what is illustrated is set forth only for the purposes of example and that it should not be taken as a limitation in the scope of the present apparatus and method of use.

### DETAILED DESCRIPTION OF THE INVENTION

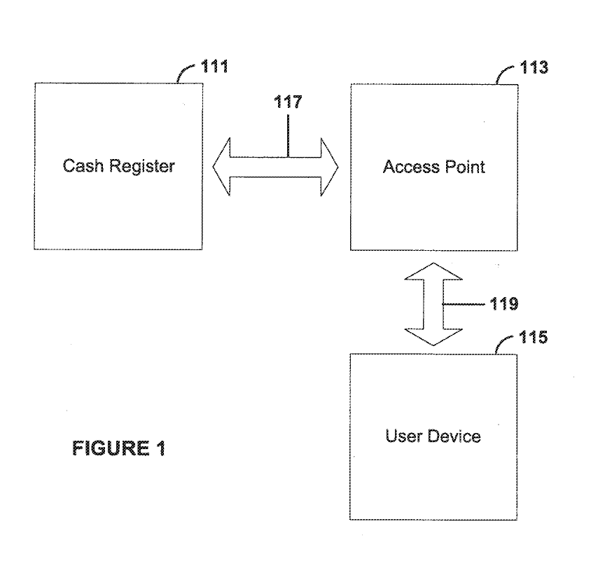

A location or venue includes a configuration in accordance with aspects of the invention as in FIG. 1. In various embodiments the location or venue may be a retail environment, designated public area, hotel room, trade show, restaurant, coffee shop, bookstore, airport, bus, subway, airplane, ferry, ship, train, sports stadium, mall, open space, area or zone within a city, or other location.

A user device 115 such as a laptop computer, PDA, Wi-Fi® phone, cellular phone, mobile handset, other portable device, or other computer based device is in data communication with an access point 113 via a communications link 119. The access point generally provides access to a network (not shown). The access point uses an access code to permit the user device to access the network.

Thus, for example, after the access point receives the access code from the user device, the access point thereafter allows the user device to access the network. In some embodiments the access point determines if the access code is proper, while in other embodiments another device, such as a device associated with the access point, may perform this function. In general, determining if an access code is proper may simply comprise determining if the access code is in a list of valid access codes, but more generally may include processing using the access code, for example, shared secret processing or other key related processing.

As shown in FIG. 1, a cash register 111 is also in data communication with the access point via a communications link 117. In most embodiments, the cash register provides the user device, or more often, a user associated with the user device, the access code, generally as a result of a commercial transaction for goods or services other than the service of access to the network. In some embodiments the cash register determines the access code for provision to the user. In many embodiments the access point, or some other device associated or communications with the access point, determines the access code and provides the access code to the cash register for provision to the user.

Note the user device 115 in many embodiments does not actually have to be located within the physical confines of the venue, rather it may be in the vicinity of the venue or proximity of the venue. Similarly, the access point 113 may be located, in some embodiments, in the vicinity of the venue or proximity of the venue instead of physically within the bounds of the venue.

As mentioned above, the access point 113 provides access to a network. For example, access to the network may be an entry point to a network where the user device 115 or the cash register 111 is able to send and receive data messages to and from another computer or device on the network. The user device 115 data couples, or connects, to the access point 113 for communication. For example, the user device 115 connects to the access point 113 for sending and receiving data messages to and from network components via the access point 113.

Examples of access points are the WCG200, WRT54G, and WAP546 by Linksys (www.linksys.com). In some embodiments, the access point has additional features. Firstly, the access point 113 may have the capability to determine access codes (ACs). In one embodiment, determining the AC comprises computing the AC. In an alternative embodiment, determining an AC comprises generating the AC. In another alternative embodiment, determining an AC involves a query to a RADIUS server or database. Secondly, the access point 113 in one embodiment contains a database used to store the access code, and possibly information associated with the access code, such as access allotment, or other information.

The cash register 111 is used for commercial transactions. The cash register 111 may also be connected to the access point 113. For example, the cash register 111 connects to the access point for sending and receiving data messages to and from network components via the access point 113. In most embodiments the cash register is a business machine that usually has a money drawer, indicates the amount of each sale, records the amount of money received, prints a receipt for the transaction, has a processor and memory, and may contain I/O interfaces for connecting peripherals. The I/O interfaces may include VGA, USB, RS-232, RJ-45 for Ethernet, and RS-485, wireless interfaces such as IEEE 802.11, Bluetooth, or any other wireless based interface. Examples of the types of peripherals that might be connected to cash register 111 include but are not limited to credit card swipe, printer, video monitor, payment capture device, wireless interface, optical scanner, and credit card processing terminal. When a peripheral is connected with the cash register 111 then it is considered to be part of the cash register 111. Examples of such cash registers include the IBM SurePOS 700 Series, the NCR RealPOS 80 Point-of-Service Workstation, or the Micros 3700. In other embodiments, the cash register 111 may be a stand alone credit card processing terminal. An example of a credit card processing terminal is the VX 570 offered by VeriFone. The VX 570 may include an Ethernet port for standard TCP/IP communications.

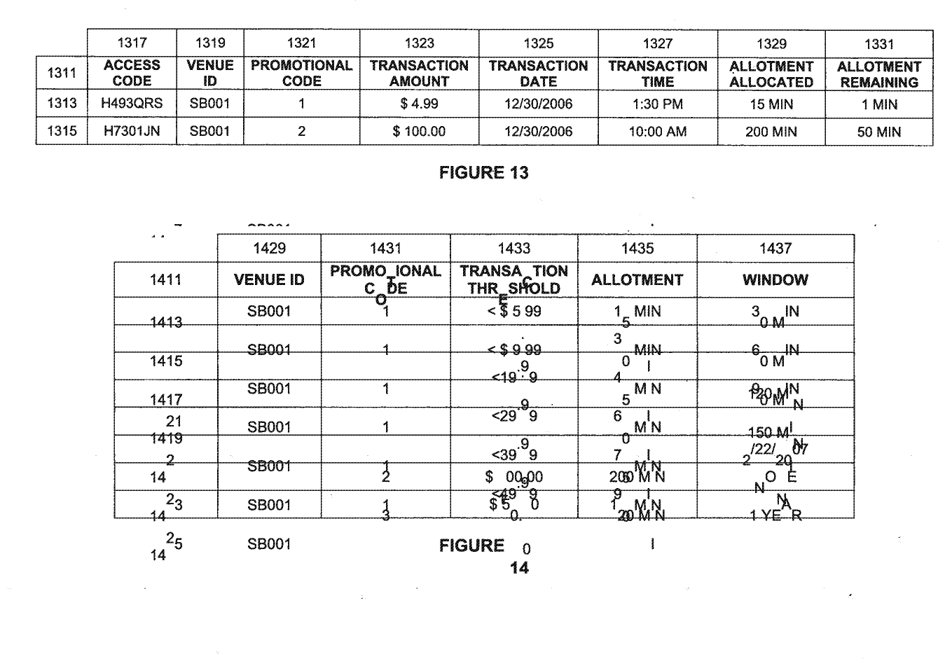

The database may be used to store the AC and information associated with the AC such as an allotment, such as an allotment of time, data, or other quantity, associated with the AC. In one embodiment, the database may be integrated with the access point 113. In this embodiment the access point 113 may communicate the AC to the cash register 111. In an alternative embodiment, the database may be integrated with the cash register 111. In this embodiment the cash register 111 simply provides the AC and additionally may communicate the AC to the access point 113 or other devices or computers on the network. In another alternative embodiment, the database is located external to both the access point 113 and external to the cash register 111, a stand alone database. In this embodiment, the database may communicate the AC to the cash register 111 or other devices or computers on the network. In another embodiment the database may be located partially in the cash register 111 and partially in the access point 113. In this embodiment the access point 113 or the cash register 111 may each communicate the AC or information about the AC to each other or other devices or computers on the network. In another embodiment, the cash register 111 may have a database integrated within it and a database external to the cash register may be available and have duplicate AC code information and duplicate information about the AC. In other embodiments, the database may be a RADIUS server located external to both the cash register 111 and access point 113. In simplest form the AC is available to the cash register 111 and to the access point 113, no database necessary. The database is not depicted in FIG. 1. The database may simply be flat files, may include relational tables such as those depicted in FIGS. 13-15, or may be data stored in registers.

According to FIG. 1 the cash register 111 connects to the access point 113 via communications link 117. Data messages from or to the access point may travel on a wire or wirelessly. Communications link 117 in some embodiments is a wired communications link. In some embodiments, communications link 117 may be a standard wireless cellular phone connection as is known to those skilled in the art. In other embodiments, communications link 117 may be an EV-DO, GPRS or other data link across a cellular communications network. In another alternative embodiment, communications link 117 may be a standard Ethernet communications link. In each of the communication link 117 embodiments described herein there may include switches, routers and hubs, not shown in FIG. 1, between the cash register 111 and the access point 113. Depending on the type of communications link 117 selected, the cash register 111 and access point 113 will have the necessary hardware and software to communicate across the selected type of communications link 117. Communications link 117 may be a secure link. However, communications link 117 does not necessarily need to be designed to be secure.

According to FIG. 1 the access point 113 connects to the user device 115 via communications link 119. Data messages from or to the access point may travel on a wire or wirelessly. In most embodiments, communications link 119 is a standard wired or wireless Ethernet communications link. In alternative embodiments, communications link 119 may be a standard wireless cellular phone connection as is known to those skilled in the art. In other embodiments, communications link 119 may be an EV-DO, GPRS or other data link across a cellular communications network. In another alternative embodiment, communications link 119 may be a standard Ethernet communications link. In each of the communication link 119 embodiments, described herein there may be switches, routers and hubs, not shown in FIG. 1, between the user device 115 and the access point 113. Depending on the type of communications link 119 selected, the user device 115 and access point 113 will have the necessary hardware and software to communicate across the selected type of communications link 119. Communications link 119 may be a secure link. However, communications link 119 does not necessarily need to be designed to be secure.

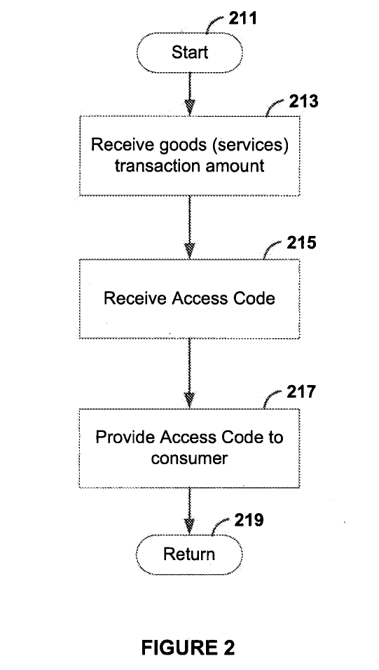

FIG. 2 shows a flow chart of a process for providing an access code. The process may be performed, for example, by the system of FIG. 1. For example, the process elements in FIG. 2 may be executed individually or in combination with either the user device 115, the access point 113, the cash register 111 or the database, not shown. The process receives a transaction amount for goods or services in block 213. In most embodiments the transaction amount is for a commercial transaction. In one embodiment, the transaction amount for the goods or services comprises entering the transaction amount 213 in a cash register 111, the cash register 111 receives the transaction amount. The process receives an access code in block 215. In one embodiment, receiving an access code comprises the cash register 111 receiving the AC 215 from the access point 113. In an alternative embodiment, the process receiving an access code in block 215 comprises the cash register 111 determining the AC without input from the access point 113. In another alternative embodiment for block 215, the access point 113 may receive the AC from the database. In another alternative embodiment for block 215, the cash register 111 receives the AC 215 from its own memory. In another alternative embodiment for block 215, the access point 113 may receive the AC from a RADIUS server. In an alternative embodiment, the cash register 111 may compute the AC without the need of input from the access point 113 or the database. In block 217 the process provides the access code to a consumer. In one embodiment, providing the access code to a consumer comprises a receipt printed out from the cash register 111 in order to provide the access code to the customer 217.

A commercial transaction comprises a transfer or provision of goods or services in exchange for a payment. The delivery of the goods or services does not necessarily occur when the payment occurs. The delivery of the goods or services independent of the payment may be considered a commercial transaction. The payment whether a good or service is then received is also considered a commercial transaction. In one embodiment a commercial transaction may be a purchase of coffee at a retail establishment. In this example, the payment of money is tendered for a good or service at the time the good is delivered. Other examples of this type of commercial transaction may be the purchase of a car, books, groceries, alcohol, movie ticket, soda from a vending machine, admission to a theme park. In another embodiment a commercial transaction may be a customer purchasing a subscription. In this example, a commercial transaction occurs when the customer purchases the subscription initially as well as each time the subscription is fulfilled. An example of this type of commercial transaction is cable television. Each month the cable customer enters into a commercial transaction by paying for cable service. Additionally, a commercial transaction occurs each time the customer turns on the cable television and watches a program because the cable television company is delivering on the subscription. Similarly, a wireless phone subscriber enters a commercial transaction each month by paying his monthly bill. Additionally, each time the wireless phone subscriber uses the wireless phone a commercial transaction occurs. Another type of commercial transaction may be when payment is not tendered in money but rather in something else that has value such as frequent flyer miles, gift certificates, credits or other value that is non-monetary. For example, a customer of an airline may make payment for network access using an allotment of frequent flyer miles as payment.

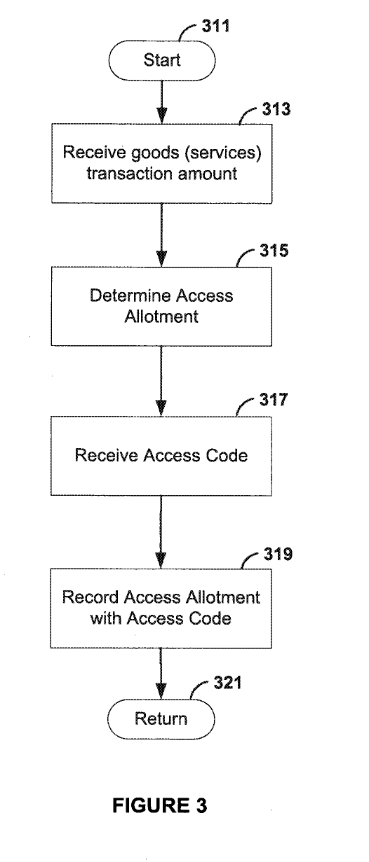

FIG. 3 shows a flow chart of a process for providing an access code in conjunction with use of a database. The process may be performed, for example, by a system such as FIG. 1 interacting with a database. For example, the process elements in FIG. 3 can be executed individually or in combination either at the user device 115, the access point 113, the cash register 111 or the database, not shown. The process receives a transaction amount for goods or services in block 313. In one embodiment, a commercial transaction takes place as described above and the transaction amount for the goods or services is entered in block 313 in a cash register 111. The process determines access allotment in block 315. In one embodiment, the cash register 111 determines the access allotment 315. In one embodiment, determining the access allotment comprises querying a database. In an alternative embodiment, determining the access allotment comprises performing a computation based on the transaction amount of goods or services. In an alternative embodiment, the cash register 111 determines the access allotment from its own memory.

The process in block 317 receives the access code. In one embodiment, the cash register 111 receives the access code 317 from the access point 113. In an alternative embodiment, the cash register 111 determines the AC without input from the access point 113. In another alternative embodiment, the access point 113 receives the AC from the database. In another alternative embodiment, the access point receives the AC from the RADIUS server. In another alternative embodiment for block 317, the cash register 111 receives the AC 317 from its own memory. In an alternative embodiment, the cash register 111 computes the AC without the need of input from the access point 113 or the database. In this case, process may skip block 317. In block 319 the process records the access allotment with the access code. In one embodiment, the cash register 111 records in the database the access allotment with the access code 319.

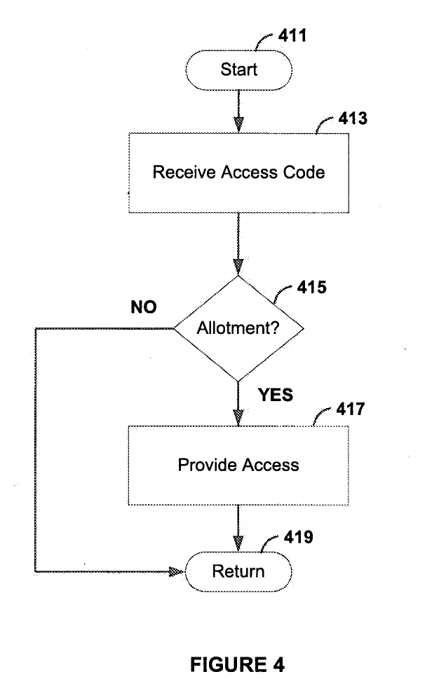

FIG. 4 shows a flow chart of a process for how the system in FIG. 1 grants access to a network. Typically a user of a user device 115 is in the vicinity or proximity of a venue containing the elements in FIG. 1 after entering into a commercial transaction for goods or services with the venue owner/operator. In block 413 the process receives an access code. In one embodiment, the process receives an access code 413 comprises the user entering the access code 413 issued to him by some of the methods described in FIGS. 2 and 3. In block 415 the process verifies that an allotment exists. In one embodiment, the access point 113 checks to verify that an allotment exists under the AC 415. In one embodiment, verifying that an allotment exists comprises validating the access code, for example, determining if the access code comprises a valid access code or key. In another embodiment, verifying that an allotment exists comprises validating the access code and checking the remaining allotment. In an alternative embodiment, verifying that an allotment exists comprises validating the access code, checking the remaining allotment and verifying that the window has not expired. In some embodiments, in order to perform 415 the access point 113 may communicate with the cash register 111, the database or both. In block 417 the process provides access to the network. In one embodiment, the access point 113 provides access to the network 417. In the event that the allotment fails to exist under the users AC then the process does not allow access to the network. In one embodiment, the process not allowing access comprises the access point 113 not allowing access to the network.

The system shown in FIG. 1 depicts the elements for a single venue configuration. It is also contemplated in the instant invention that multiple related venues may be configured. For example the system of FIG. 1 may be connected to another system similar to FIG. 1 via the Internet to the access points. In such a multiple venue configuration, a commercial transaction that occurs at one venue may allow for the granting of network access at another related venue. For example, a customer may perform a commercial transaction at a coffee shop chain. The customer may instead of sitting down at the coffee shop, where the commercial transaction took place, drive to another coffee shop in the same chain and sit down there and gain access to the network.

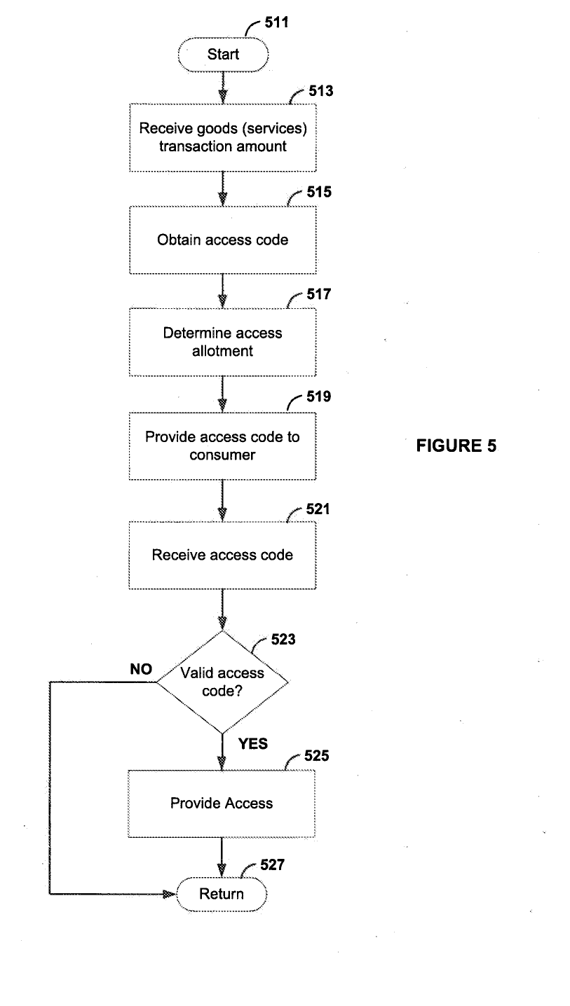

The process elements in FIG. 5 can be executed individually or in combination either at the user device 115, the access point 113, the cash register 111 or the database, not shown. The process receives a transaction amount for goods or services in block 513. The process in block 515 obtains an access code. In block 517 the process determines access allotment. The process in block 519 provides an access code to a consumer. In block 521 the process receives an access code. In block 523 the process verifies the access code. If the access code is valid, then the process in block 525 provides access. Otherwise, if the access code is invalid, then access is not provided and the process proceeds to block 527.

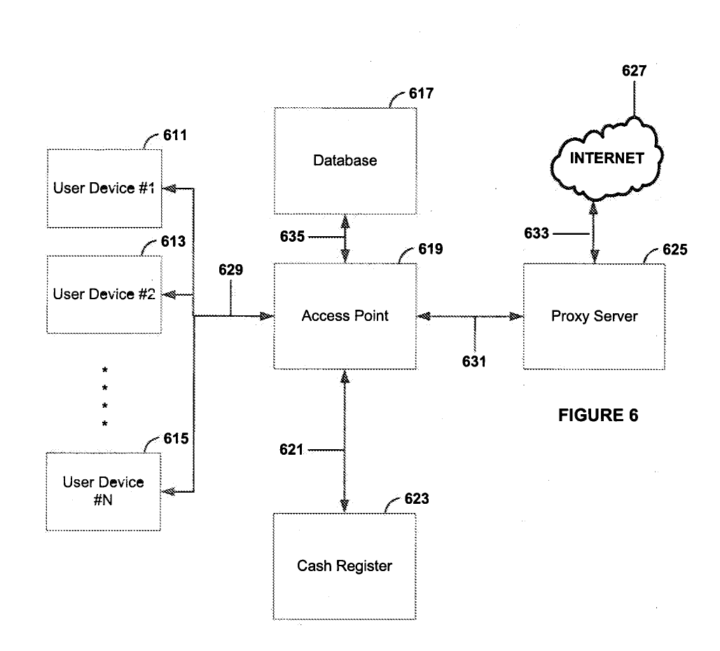

FIG. 6 shows a system configured for a single venue. The system contains an access point 619, an cash register 623, a database 617, a proxy server 625, and a plurality of user devices 611, 613, 615. The access point 619, database 617, and proxy server 625 can each individually be located at the venue or at a location apart from the venue. In some embodiments, the access point 619 connects to the Internet with out the use of the proxy server 625. In otherwords, the proxy server 625 is optional. Although the database 617 is shown to be separate from the access point 619, it is important to realize that the database can be located inside the cash register 623, or inside the access point 619 or be partially inside the access point 619 and the cash register 623. Although FIG. 6 shows a single cash register 623, in alternative embodiments there are a plurality of cash registers similar to cash register 623.

The plurality of user devices 611, 613, 615 may connect to the access point 619 via communications link 629. As discussed previously the user devices 611, 613, 615 can be laptop computers, PDAs, Wi-Fi® phones, cellular phones, mobile handsets, other portable devices, or other computer based devices. Although FIG. 6 shows a plurality of user devices 611, 613, 615, it is not required that all of the user devices communicate with the access point 619 at the same time. In one embodiment, one user device may be in the vicinity or proximity of the venue communicating via communications link 629. Alternatively, it is also an embodiment, that a plurality of user devices may communicate across communications link 629 simultaneously. Note the user devices 611, 613, 615 do not actually have to be located at the venue rather they may be in the vicinity of the venue or proximity of the venue.

The access point 619, similar to the access point 113 in FIG. 1, can be a device that provides access to a network. Examples of access points are the WCG200, WRT54G, and WAP546 by Linksys (www.linksys.com). In some embodiments, the access point may have several additional features. Firstly, the access point 113 may have the capability to determine the ACs. In one embodiment, determining the AC comprises computing the AC. In an alternative embodiment, determining the AC comprises generating the AC. In another alternative embodiment, determining the AC involves a query to a RADIUS server or database. Secondly, the access point 619 in one embodiment contains a database.

The proxy server 625 is a computer. The proxy server executes software that allows it to control access to the communications link 633. In most embodiments, the proxy server 625 manages all Internet related communications by monitoring Internet Protocol (“IP”) source and destination addresses, port numbers, and various other information inside standard Ethernet packets. The proxy server 625 uses rules to determine which Ethernet packets are allowed entrance or exit to and from the proxy server 625. Generally, the rules are programmed into software that executes on the proxy server 625 computer. The functions of the proxy server 625 and its make up are generally known to those skilled in the art. In some embodiments the proxy server 625 delivers cached web pages. In alternative embodiments, the proxy server 625 forces a user device to browse a web page so the user may authenticate himself before freely surfing the Internet. The proxy server 625 is optional and in many embodiments is not part of the design. In alternative embodiments, the access point 619 may partially perform proxy server functions. In another alternative embodiment, the access point 619 performs all of the proxy server functions.

The database may be used to store the AC and information about the AC such as the allotment of time associated with the AC. In one embodiment, the database may be integrated with the access point 619. In this embodiment the access point 619 may communicate the AC to the cash register 623. In an alternative embodiment, the database may be integrated with the cash register 623. In this embodiment the cash register 623 simply provides the AC and additionally may communicate the AC to the access point 619 or other devices or computers on the network. In another alternative embodiment, the database is located external to both the access point 619 and external to the cash register 623, a stand alone database. In this embodiment, the database may communicate the AC to the cash register 623 or other devices or computers on the network. In another embodiment the database may be located partially in the cash register 623 and partially in the access point 619. In this embodiment the access point 619 or the cash register 623 may each communicate the AC or information about the AC to each other or other devices or computers on the network. In another embodiment, the cash register 623 may have a database integrated within it and a database external to the cash register may be available and have duplicate AC code information and duplicate information about the AC. In other embodiments, the database may be a RADIUS server located external to both the cash register 623 and access point 619. In other alternative embodiments, the database 617 may be a part of the proxy server 625. In simplest form the AC is available to the cash register 623 and to the access point 619, no database necessary. The database may simply be flat files, may include relational tables such as those depicted in FIGS. 13-15, or may be data stored in registers.

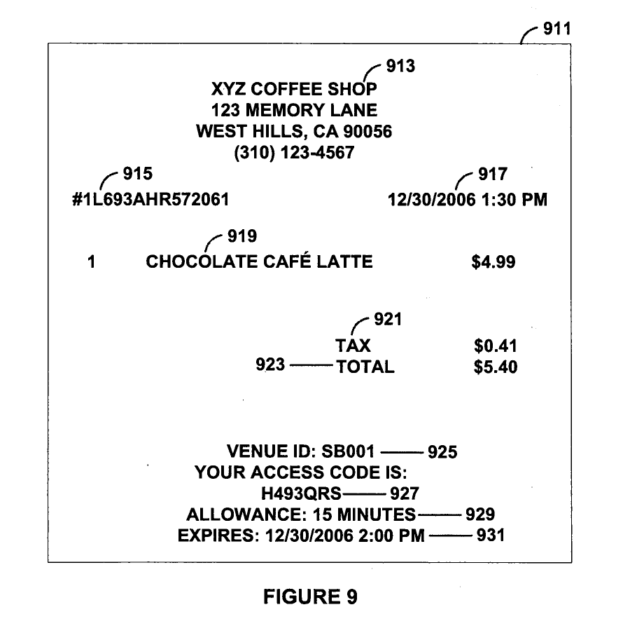

The cash register 623 is similar to the cash register 111. In some embodiments the cash register 623 may print out a receipt with an AC. An example of such a receipt may be seen in FIG. 9.

In most embodiments, communications links 629, 635, 621, and 631 are standard wired or wireless Ethernet communications link. In alternative embodiments, these communications link may be a standard wireless cellular phone connection as is known to those skilled in the art. In other embodiments, these communications links may be an EV-DO, GPRS or other data link across a cellular communications network. Depending on the type of communications links selected, the user devices 611, 613, 615, database 617, access point 619, cash register 623, and proxy server 625 will all have the necessary hardware and software to communicate across the selected type of communications links. In each of the communication link embodiments, described herein there may be switches, routers and hubs, not shown in FIG. 6. These communications links may be secure links. However, these communication links do not necessarily need to be designed to be secure. Communications links 629, 635, 621 and 631 do not all have to be the same type of communications links.

In most embodiments, communications link 633 is a standard DSL, Wireless Cable, Cable modem, Optical or T1 link that is capable of transporting standard Ethernet based communications. In alternative embodiments, communications link 633 may be a standard wireless cellular phone connection as is known to those skilled in the art. In other embodiments, communications link 633 may be an EV-DO, GPRS or other data link across a cellular communications network. In each of the communication link embodiments, described herein there may be switches, routers and hubs, not shown in FIG. 6. Depending on the type of communications link 633 selected, access point 619, or optionally proxy server 625 will have the necessary hardware and software to communicate across the selected type of communications link 633. Communications link 633 may be a secure link. However, communications link 633 does not necessarily need to be designed to be secure.

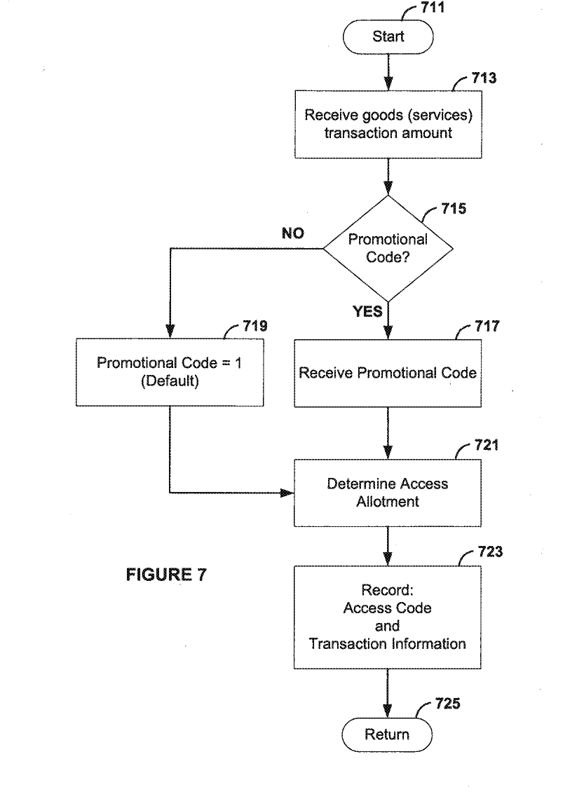

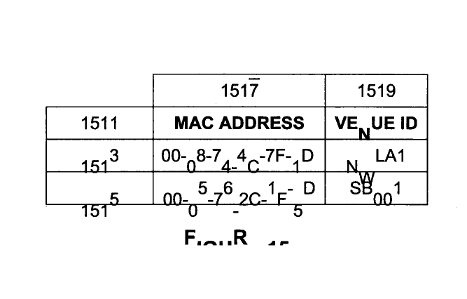

FIG. 7 shows a flow chart of a process for how the system in FIG. 6 handles a commercial transaction. The process in 713 receives the goods or services transaction amount. In one embodiment, the goods or services transaction amount is entered in the cash register 623. In block 715 the process may receive a promotional code. If no promotional code is available then the promotional code is default such as 1, 719. Otherwise, a promotional code is received by the process at 717. Next in block 721 of the process the access allotment is determined. In some embodiments, this determination may be a query to a database table such as the table depicted in FIG. 14. For example row 1413 shows that if the promotional code is 1 (default) and the transaction amount is less than $5.99 then an allotment of 15 minutes is allocated. In other embodiments, this determination may be a computation that executes inside the cash register 623 for computing the access allotment. In block 723 of the process a record is created, recording the access code along with other transactional information.

In most embodiments, the AC may be an alpha-numeric number. This number may simply increment each time an access code is assigned to a transaction. In other embodiments the access code may be a number. This number may simply increment each time an access code is assigned to a transaction. Alternatively, the AC may be a random number or a random alpha-numeric number. The number or alpha-numeric may be generated randomly from a random number generator. In most embodiments the access code is unique to the system that it is being implemented in. Once an AC is recorded in a record such as the record in row 1313, then the AC has been assigned and should not be assigned again at least until the window expires. In an alternative embodiment, the AC can be the transaction ID. In other embodiments, the AC can be an airline record locator number or a frequent flyer number. In other embodiments the AC may be a user name and password.

FIG. 13 shows an database table with the AC as the primary key. Row 1313 depicts a sample record. The elements included in the record, FIG. 13, row 1313 are the access code, venue ID, promotional code, transaction amount, transaction date, transaction time, allotment allocated and allotment remaining. In alternative embodiments, the record is not limited to these elements and may include other elements and possibly less elements in the record. For example, the column allotment allocated 1329 may be optional since it is the same as column 1435 in the database table in FIG. 14. A record as stated above is a row in FIG. 13, such as row 1313 or row 1315. A Column in FIG. 13 depicts a single element for the records in the table. For example, column 1325 shows the transaction date elements for each of the records in rows 1313 and 1315.

Column 1317 shows all of the ACs for each of the records in the table. An AC has been described previously. Column 1319 shows all of the Venue IDs for each of the records in the table. A venue ID may be comprised of a number, alpha-numeric number, letter, word, or symbol that uniquely identifies each venue or location. For example, if a coffee shop chain has 10 different locations then each of the 10 different location will be assigned a unique venue ID. Alternatively, a single venue ID may be assigned to each of the different locations. Column 1321 shows all of the promotional codes used in each of the records in the table. A promotional code may be comprised of a number, alpha-numeric number, letter, word, or symbol that helps identify the type of transaction. For example, a promotional code of 1 defines a transaction where the allotment is determined by the transaction amount. For example, if the promotional code is 1 and the transaction amount is less than $5.99 (the transaction threshold) then the allotment remaining will be set to 15 minutes giving the user of a particular AC 15 minutes of access. If the transaction amount had been greater than $5.99 but less than $9.99 then the allotment remaining will be set to 30 minutes giving the user of a particular AC 30 minutes of access. Column 1323 shows all of the transaction amounts used in each of the records in the table. The transaction amount may be comprised as the actual dollar amount spent in a commercial transaction, a number or alpha-numeric number related to the amount spent in a commercial transaction, or a letter, word, or symbol related to the amount spent in a commercial transaction, frequent flyer miles, number of watts used in a power grid, minutes in a wireless cellular network or any number, alpha-numeric number, letter, word, or symbol that relates to something of value. The tax in a commercial transaction may or may not be included in the transaction amount. For example if a customer at a coffee shop purchases a cup of coffee for $4.99 then the transaction amount will be stored in the database table as $4.99 in column 1323. Column 1325 shows all of the transaction dates in each of the records in the table. The transaction date may be comprised as the actual date the commercial transaction occurred, a number related to the actual commercial transaction date such as the julian date, or may be an alpha-numeric number, letter, word, or symbol related to the actual commercial transaction date. Column 1327 shows all of the transaction times in each of the records in the table. The transaction time may be comprised as the actual time the commercial transaction occurred. The transaction time may be expressed with a 12 hour clock, a 24 hour clock, or a number related to the actual time the commercial transaction occurred. Column 1329 shows all of the allotments allocated in each of the records in the table. The allotment allocated may be comprised as a number, alpha-numeric number, letter, word or symbol that describes an amount of access allocated to an AC. For example, an allotment allocated may be the number of minutes of access time. Or, an allotment allocated may be the number of mega bytes allowed to download or upload or both to a network. Column 1331 shows all of the allotments remaining in each of the records in the table. The allotment remaining may be comprised as a number, alpha-numeric number, letter, word or symbol that describes an amount of access remaining to an AC. For example, an allotment remaining may be the number of minutes of access time left in a users session. Or, an allotment remaining may be the number of mega bytes remaining to download or upload or both to a network. It should be noticed to those skilled in the art that FIGS. 13 and 14 represent tables in a relational database. Thus in order to get all of the information required, queries to both tables may be necessary depending on which information is in each of the tables. FIGS. 13 and 14 show data in the table with its units. For example in, row 1313 column 1331, the table contains the element 1 MIN. The units displayed in FIGS. 13 and 14 are for illustrative purposes only. Those skilled in the art will understand that the units may not necessarily be included in the database tables. FIG. 14 shows an database table. This database table determines the allotments granted and window periods assigned given the transaction amounts, promotional code, and venue ID. In most embodiments, the table in FIG. 14 is determined in advance prior to any commercial transactions. Row 1413 depicts a sample record. The elements included in the record, FIG. 14, row 1413 are the venue ID, promotional code, transaction threshold, allotment, and window. In alternative embodiments, the record is not limited to these elements and may include other elements and possibly less elements in the record. A Column in FIG. 14 depicts a single element for the records in the table. For example, column 1433 shows the transaction threshold elements for each of the records in rows 1413-1427.

Column 1429 shows all of the venue IDs for each of the records in the table in FIG. 14. The venue ID was discussed previously and is the same as the venue ID in FIG. 13. Column 1431 shows all of the promotional codes used in each of the records in the table in FIG. 14. The promotional code was discussed previously and is the same as the promotional code in FIG. 13. Column 1433 shows all of the transaction thresholds for each of the records in the table in FIG. 14. The transaction threshold may be comprised as an actual dollar amount spent in a commercial transaction, a number or alpha-numeric number related to the amount spent in a commercial transaction, or a letter, word, or symbol related to the amount spent in a commercial transaction, frequent flyer miles, number of watts used in a power grid, minutes in a wireless cellular network or any number, alpha-numeric number, letter, word, or symbol that relates to something of value. The transaction thresholds are used to group various transaction amounts and assign particular allotments and windows. For example, if a customer enters into a transaction at venue ID=SB001 and the promotional code=1 and the transaction amount is greater than $5.99 but less than $9.99 (transaction threshold) then the allotment will be assigned 30 minutes with a window of 60 minutes. The transaction thresholds in this example are used to assign the correct allotment and window. In row 1425 and 1427 the transaction thresholds are valid only when the transaction amount is equal to the transaction threshold. This type of transaction threshold, in some embodiments represent situations when a customer wants to purchase straight access time allotment. For example, in row 1425, if a clerk enters an amount of $100.00 and a promotional code of 2 then the access code will be assigned an allotment of 200 minutes with no expiration window. In row 1427, if a clerk enters an amount of $50.00 and a promotional code of 3 then the access code will be assigned an allotment of 120 minutes but with an expiration window of one year from the commercial transaction date. Column 1435 shows all of the allotments used in each of the records in the table in FIG. 14. The allotments in column 1435 is the same as the allotments allocated in column 1329 in FIG. 13 and was discussed previously. Column 1437 shows all of the windows for each of the records in the table in FIG. 14. The window may be comprised as the amount of time that the AC is valid following the date and time of the commercial transaction. The window may be expressed with a 12 hour clock, a 24 hour clock, minutes, seconds, or a number related to time such as the julian date. For example in row 1423, the window is for a period of time that begins on the date and time that the commercial transaction occurred and ends on a specific date Feb. 22, 2007. This means that the access code will expire or be invalid on the date Feb. 22, 2007. Whereas, in row 1413 the window is 30 minutes. This means that the window is for a period of time that begins on the date and time that the commercial transaction occurred and ends 30 minutes later. Row 1425 shows that there is no window. Thus, this type of transaction will have an AC that will be good until all of the access time is used up.

As can be seen by those of skill in the art the tables in FIGS. 13 and 14 can be configured to handle any sales, marketing or promotion of access one can think of. FIG. 14 shows data in the table with its units. For example in, row 1413 column 1437, the table contains the element 30 MIN. The units displayed in FIG. 14 are for illustrative purposes only. Those skilled in the art will understand that the units may not necessarily be included in the database table. Additionally, the format of the elements are for illustrative purposes only. For example, the element in row 1413, column 1433 is <$5.99. The less than symbol may not actually be included in the table. Rather the function less than (<) may be implemented in software code.

FIG. 15 shows an database table. This database table determines which venues have access to the network. In some embodiments, the table in FIG. 15 is determined in advance prior to any commercial transactions. Row 1511 depicts a sample record. The elements included in the record, FIG. 15, row 1511 are MAC address and the venue ID. In alternative embodiments, the record is not limited to these elements and may include other elements and possibly less elements in the record.

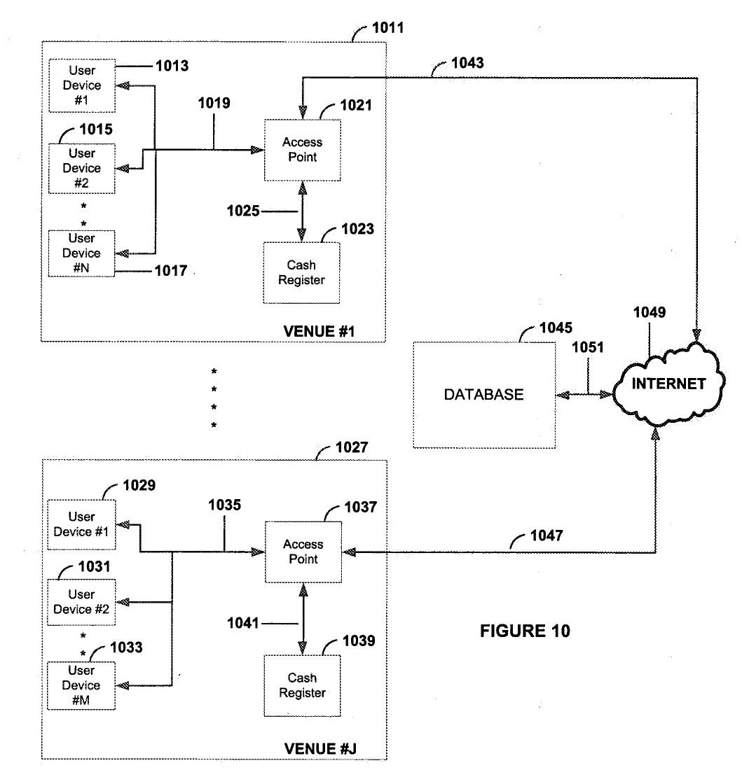

The MAC address comprises the identification of the Network Interface Card (“NIC”) of the either the access point 1119 or the optional proxy server 1123. In a multiple venue embodiment, such as that in FIG. 10, the table in FIG. 15 will be queried to ensure that the access point or proxy server is identified. If the MAC address is matched up against a venue then access may be granted. However, if the MAC address is not matched up to a venue then access will be denied.

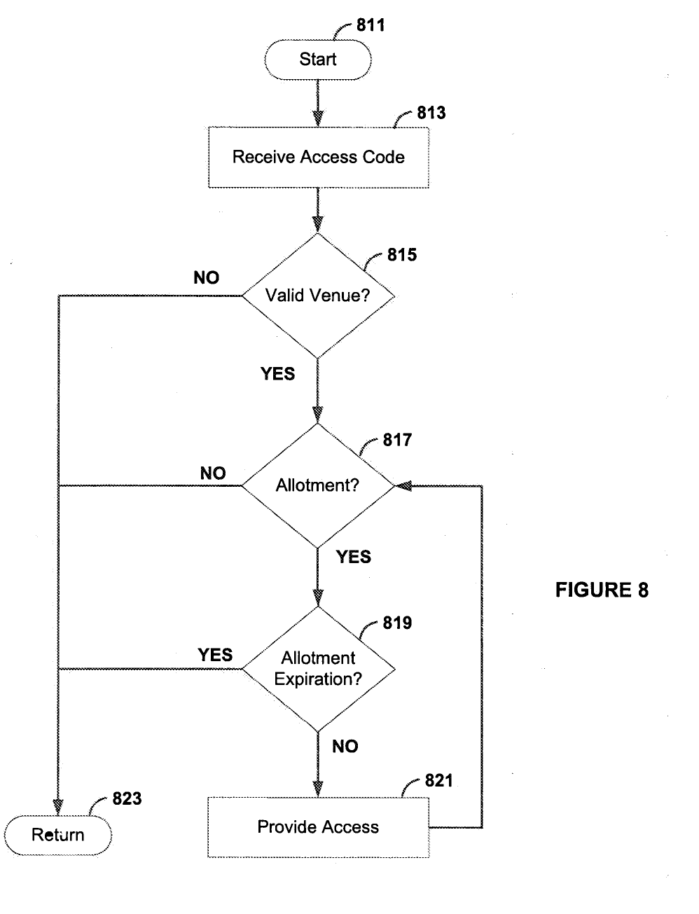

FIG. 8 shows a flow chart of a process for how the system in FIG. 6 grants access to a network. In block 813 of the process the AC is received. In one embodiment, the AC may be entered into the cash register 623. In block 815 of the process the venue ID is checked. In some embodiments, process block 815 is optional in a single venue configuration as in FIG. 6. In a single venue configuration process 815 may be used to prevent intruders from unauthorized locations from gaining access to the network. In a multiple venue configuration process 815 is important because only authorized venues are allowed to access the network. In one embodiment, the venue ID may be checked by examining the MAC address in the Ethernet type communications. Once the MAC address is determined, a queries to other tables such as the table in FIG. 14 may be performed. If the MAC address is associated with a venue ID then the check is complete. In another embodiment, the venue may be validated by simply presenting the user with an opportunity to enter the venue ID. The venue ID in this embodiment may be printed on a receipt such as the receipt in FIG. 9. If the venue ID is valid the process continues to block 817 otherwise, the process returns to block 823. In block 817 the process verifies that an allotment exists. In one embodiment, the access point 619, cash register 623, database 617, or proxy server 625 checks to verify that an allotment exists under the AC 817. In another embodiment, verifying that an allotment exists comprises validating the access code. In another embodiment, verifying that an allotment exists comprises validating the access code and checking the remaining allotment. In some embodiments, the access point 619, cash register 623, database 617, or proxy server 625 may communicate with each other individually or in plurality. In block 819 the allotment expiration is checked 819. In some embodiments, if the allotment exits then the window is checked against the current date and time. If the window has expired, then access is denied. Finally, if the window has not expired access is allowed 821. According to the process loop between 821 and 817 the allotment and allotment expiration are repeatedly checked at any interval chosen by the venue operator. While providing access in 821 the allotment remaining may be updated in the database every so often in order to keep the data accurate.

FIG. 9 shows a sample printed receipt 911. At the top of the receipt is the name, address, and telephone number of the venue 913. At 915 is a transaction ID. The transaction ID is used to track each transaction the venue operator creates. At 917 is the time and date stamp of the actual transaction. 919 describes the goods or services sold in the transaction. 921 indicates the tax added on to the transaction. 923 shows the total amount of the transaction including tax. 925 shows the venue ID for where network access may be granted. If access may be granted at more than one venue then multiple venue IDs may be displayed. Venue IDs may be coded in such a way that a single venue ID may provide access at multiple different venues. 927 shows the access code. 929 shows the amount of access granted. In this example 15 minutes was granted. 931 shows the date and time that the access will expire. While the transaction ID 915 is indicated on receipt 911 it is in most embodiments a unique number. The transaction ID 915 in an alternative embodiment may be used as the access code 927. In an alternative embodiment, the venue ID may not be shown at all.

FIG. 10 shows a multiple venue configuration where venue #1 through venue #J (J is an integer) are related. The first venue in FIG. 10 is the venue depicted in 1011. The last venue related to venue 1011 is venue #J 1027. In this particular multiple venue embodiment venue 1011 contains user devices 1013, 1015, 1017, an access point 1021, a cash register 1023 and communications links 1019 and 1025. Venue 1011 can communicate via its access point 1021 to the central database 1045 across communications links 1043 and 1051 and the Internet. In an alternative embodiment, the venue may be comprised of an optional proxy server similar to proxy server 1025 located at the venue. The proxy server may buffer communications between the access point 1021 and the Internet along communications link 1043. In another alternative embodiment, the venue may be comprised of a database similar to database 617. The remaining venues in this embodiment are similar and will not be repeated.

The plurality of user devices 1013, 1015, 1017 may connect to the access point 1021 via communications link 1019. As discussed previously the user devices 1013, 1015, 1017 can be laptop computers, PDAs, Wi-Fi® phones, cellular phones, mobile handsets, other portable devices, or other computer based devices. Although FIG. 10 shows a plurality of user devices 1013, 1015, 1017, it is not required that all of the user devices communicate with the access point 1021 at the same time. In one embodiment, one user device may be at the venue communicating via communications link 1019. Alternatively, it is also an embodiment, that a plurality of user devices may communicate across communications link 1019.

The database 1045 is similar to database 617.

The communication links 1019 and 1035 are similar to communication links 629 and 119 will not be discussed again. Communication links 1043, 1047, and 1051 are similar to communication link 633 and will not be discussed again. Communication links 1025 and 1041 are similar to communication links 621, and 117 and will not be discussed again.

The methods for controlling network access in a multiple venue configuration as in FIG. 10 have been discussed previously and can be seen in FIGS. 2, 3, 4, 7, and 8.

According to FIG. 6 a cash register 623 is utilized for a commercial transaction. In an alternative embodiment the cash register 623 may be optionally replaced with a general computer. In either case both the cash register 623 and optionally the general computer may be capable of printing a receipt as shown in FIG. 9. In an alternative embodiment both the cash register 623 or optionally the general computer may also encode a magnetic strip on the back of a gift card with the access code information. Alternatively, the cash register 623 or optionally the general computer may also be capable of putting the access code information on a memory device such as a USB memory key, or any other non-volatile memory. The cash register 623 or optionally the general computer may also able to issue a prepaid access code card. A prepaid access code card, in an alternative embodiment, may have the AC written on the surface of the card but covered by a substance such that when scratched off the AC becomes visible. Examples of hiding information on a card can be seen in lottery tickets where the numbers can be found by scratching off a substance with a finger nail or coin.

The cash register 623 in FIG. 6 may be optionally replaced by an airline ticketing computer. An airline ticketing computer is a typical computer that issues airline tickets, boarding passes, and offers airline information. These computers typically reside in airports, kiosks, travel agencies and/or are accessed via the Internet. The software typically running on an airline ticketing computer is made by Sabre. According to the instant invention, an airline ticketing computer has the ability to issue airline tickets, boarding passes, or paper with ACs indicated on it. The algorithms for issuing ACs in this embodiment and granting access are the same as the algorithms discussed above and depicted in FIGS. 2, 3, 4, 7 and 8.

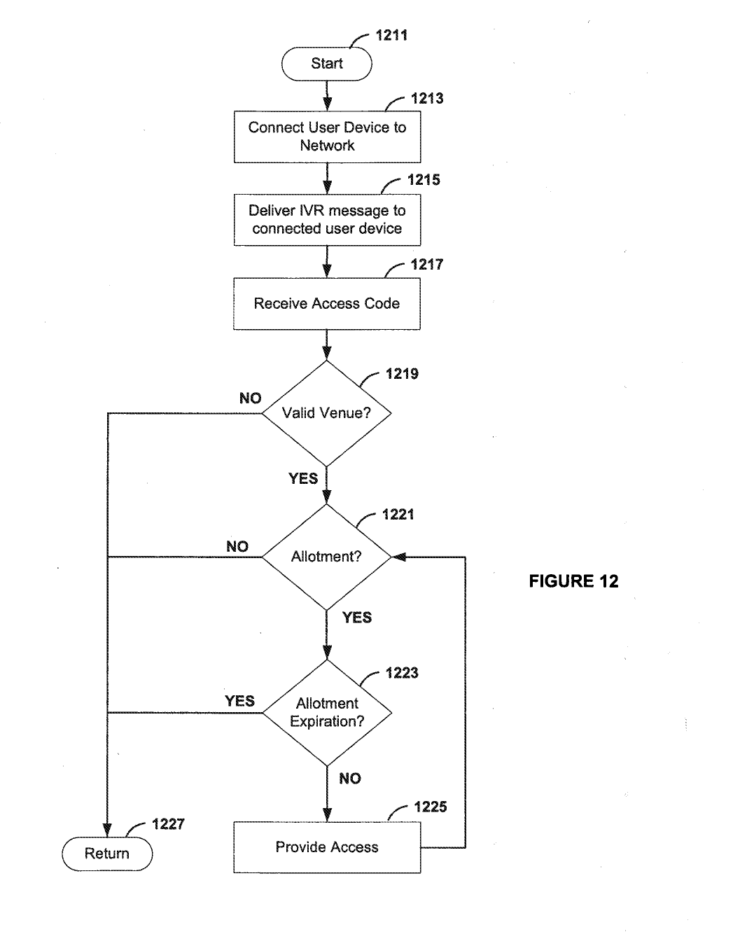

The database tables for the airline ticketing embodiment are similar to the tables depicted in FIGS. 12, 13, and 14 with the following changes. In FIG. 12 column 1217 may be changed to frequent flyer # instead of AC. And column 1223 may be changed to frequent flyer miles. In FIG. 13 column 1333 may be changed to frequent flyer mile thresholds. No changes are required in FIG. 14. The commercial transactions that take place in this embodiment will utilize the number of frequent flyer miles as payment. And the frequent flyer # or record locator number as the access code.

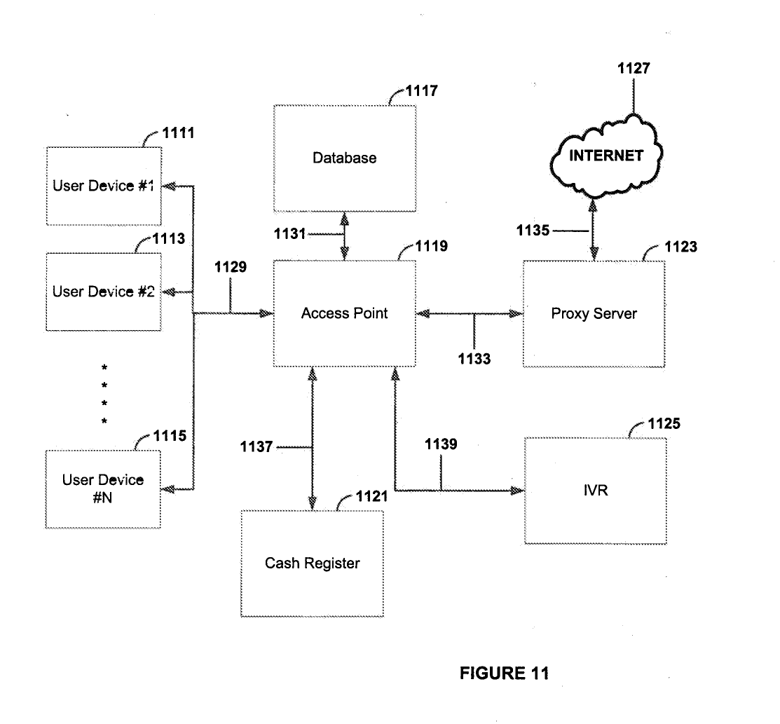

FIG. 11 shows a system configured for a single venue. The system contains an access point 1119, an cash register 1121, a database 1117, a proxy server 1123, an interactive voice response unit (“IVR”), and a plurality of user devices 1111, 1113, 1115. The access point 1119, database 1117, and proxy server 1123 can each individually be located at the venue or at a location apart from the venue. In some embodiments, the access point 1119 connects to the Internet with out the use of the proxy server 1123. In otherwords, the proxy server 1123 is optional. Although the database 1117 is shown to be separate from the access point 1119, it is important to realize that the database can be located inside the cash register 1121, or inside the access point 1119 or be partially inside the access point 1119 and the cash register 1121. Although FIG. 11 shows a single cash register 1121, in alternative embodiments there are a plurality of cash registers similar to cash register 1121.

The plurality of user devices 1111, 1113, 1115 are similar to the user devices 611, 613, 615. A discussion of user devices 1111, 1113, 1115 will not be repeated here. The optional proxy server 1123 is similar to proxy server 625 and a discussion will not be repeated. The database 1117 is similar to database 617 and a discussion will not be repeated. The cash register 1121 is similar to the cash register 623 and a discussion will not be repeated.

The IVR 1125 is a computer system that delivers pre-programmed audio messages from an audio response unit (“ARU”) either built into the IVR or separate. The IVR 1125 is also capable of receiving DTMF tones or data from user devices. Examples of IVR units include IVR products from BCE Elix, Cisco IP IVR, Apex, and Aspect. The IVR unit in the instant invention is used to deliver an audio message asking a user to enter an access code. The IVR will receive the access code and either process it according to the algorithms discussed previously or send the AC to the access point 1119 or optionally to the proxy server 1123 where the access point 1119 or optionally the proxy server 1123 will process according to the algorithms discussed previously. Additionally, the IVR 1125 may also inform the user how many minutes are left until the expiration of the AC.

The communication link 1129 is similar to communication links 119, 629, 1019 and 1035 and will not be discussed again. Communication links 1137 is similar to communication links 621, 1025, and 1041 and will not be discussed again. Communication link 1135 is similar to communication links 633, 1043, 1047, and 1051 and will not be discussed again.

Although FIG. 11 depicts a single venue configuration. In an alternative embodiment FIG. 11 can be adapted to be configured for a multiple venue configuration as in FIG. 10.

FIG. 12 shows a process for granting access to a network. The process of FIG. 12 is performed, for example, by the system of FIG. 11. A user device is connected to the network 1213. An IVR audio message is delivered to the connected user device 1215. AC is entered from user device 1217. Next, the venue ID is checked 1219. Process 1219 is optional in a single venue configuration as in FIG. 11. In a single venue configuration process 1219 is used to prevent intruders from unauthorized locations from gaining access to the network. In a multiple venue configuration this is important because only authorized venues are allowed to access the network. Next the access point 1119 checks to verify that an allotment exists under the AC 1221. In one embodiment, verifying that an allotment exists comprises validating the access code. In another embodiment verifying that an allotment exists comprises validating the access code and checking the remaining allotment. In order to perform 1221 the access point 1119 may communicate with the cash register 1121, the database 1117, the IVR 1125 or all. Next the allotment expiration is checked 1223. If the allotment exits then the window is checked against the current date and time, in most embodiments. If the window has expired, then access is denied. Finally, if the window has not expired access is allowed 1225. Next according to the loop between 1225 and 1221 the allotment and allotment expiration are repeatedly checked at any interval chosen by the venue operator. While providing access in 1225 the allotment remaining may be updated in the database every so often in order to keep the data accurate.

It should be noted that the words used in this specification to describe the instant embodiments are to be understood not only in the sense of their commonly defined meanings, but to include by special definition in this specification: structure, material or acts beyond the scope of the commonly defined meanings. Thus if an element can be understood in the context of this specification as including more than one meaning, then its use must be understood as being generic to all possible meanings supported by the specification and by the word or words describing the element.

In addition, the definitions of the words or drawing elements described herein are meant to include not only the combination of elements which are literally set forth, but all equivalent structure, material or acts for performing substantially the same function in substantially the same way to obtain substantially the same result. In this sense it is therefore contemplated that an equivalent substitution of two or more elements may be made for any one of the elements described and its various embodiments or that a single element may be substituted for two or more elements in a claim.

Changes from the claimed subject matter as viewed by a person with ordinary skill in the art, now known or later devised, are expressly contemplated as being equivalents within the scope intended and its various embodiments. Therefore, obvious substitutions now or later known to one with ordinary skill in the art are defined to be within the scope of the defined elements. This disclosure is thus meant to be understood to include what is specifically illustrated and described above, what is conceptually equivalent, what can be obviously substituted, and also what incorporates the ideas herein.

1. A method of providing access to a network, comprising:
using a cash register to provide an access code for network access for use by a user device, the access code being provided in association with a transaction for goods or services other than access to the network;
receiving the access code from the user device; and
allowing the user device to access the network.

2. The method of claim 1 further comprising determining if the access code received from the user device is proper.

3. The method of claim 2 wherein determining if the access code received from the user device is proper comprises determining if the access code is a valid access code.

4. The method of claim 1 further comprising determining an indication of whether the user device is within a venue in which the cash register is located.

5. The method of claim 1 wherein an access allotment is associated with the access code.

6. The method of claim 5 further comprising disallowing access to the network by the user device after utilization of the access allotment.

7. The method of claim 5 wherein the access allotment is a time duration.

8. The method of claim 7 further comprising disallowing access to the network by the user device at the end of the time duration.

9. The method of claim 5 wherein the access allotment is a byte allotment.

10. The method of claim 1 wherein using the cash register to provide the access code for network access comprises:
requesting the access code;
receiving the access code; and
providing the access code.

11. The method of claim 10 wherein requesting the access code comprises transmitting a request from the cash register to a device configured to provide access codes.

12. The method of claim 11 wherein receiving the access code comprises receiving the access code by the cash register from the device configured to provide access codes.

13. The method of claim 11 wherein the device configured to provide access codes is an access point.

14. The method of claim 10 wherein providing the access code comprises printing the access code.

15. The method of claim 14 wherein printing the access code comprises printing the access code on a receipt for the transaction for goods or services other than access to the network.

16. A method of providing access to a network, comprising:
receiving payment from a customer for a good or service other than provision of network access;
providing the customer a receipt for payment for the good and an access code for use in wirelessly accessing a network;
receiving the access code from a device associated with the customer;
validating the access code; and
allowing the device to access the network if the access code is valid.

17. The method of claim 16 wherein the receipt includes the access code.

18. The method of claim 16 further comprising determining the access code.

19. The method of claim 18 wherein determining the access code comprises retrieving the access code from a memory.

20. The method of claim 18 wherein determining the access code comprises calculating the access code.

21. The method of claim 18 wherein determining the access code comprises retrieving the access code from a database.

22. The method of claim 18 wherein determines the access cite comprises retrieving the access code from a RADIUS server.

23. A method for providing usage of a wide area network (WAN) to a customer of a commercial establishment through a proxy server, the method comprising:
setting a WAN access time duration according to a commercial transaction between the customer and the commercial establishment for a good or service other than WAN access time;
providing transaction information to the customer including a user access code; and
establishing data communication between a customer data processing device positioned in the physical area about the commercial establishment and the WAN through the access point using the user access code.

24. A system for providing controlled access to a network, comprising:
an access point configured for wireless communication with a plurality of user devices, configured for data communication with a network, and configured to allow specific ones of the plurality of user devices to be in data communication with the network based upon receipt of an access code from the specific ones of the plurality of user devices; and
a cash register configured to provide receipts for commercial transactions, the commercial transactions for goods or services other than network access, and configured to provide access codes.

25. The system of claim 24 further comprising a database storing the access codes.

26. The system of claim 25 wherein the database is part of the cash register, and the cash register is data coupled to the access point.

27. The system of claim 25 wherein the database is part of the access point, and the access point is data coupled to the cash register.

28. The system of claim 25 wherein the database is part of a computer device in data communication with the access point, and the access point is data coupled to the cash register.

29. A method of providing network access to a Wi-Fi enabled phone, comprising:
using a cash register to provide an access code for network access for use by a Wi-Fi enabled phone, the access code being provided in association with a transaction for goods or services other than access to the network;
receiving the access code from the Wi-Fi enabled phone; and
allowing the Wi-Fi enabled phone access to the network.
